(19) United States
(12) Patent Application Publication
(10) Pub. No.: US 2017/0136349 A1
(43) Pub. Date: May 18, 2017

(54) GAME DEVICE, CONTROL METHOD AND NON-TRANSITORY COMPUTER READABLE STORING MEDIA

(71) Applicant: CAPCOM CO., LTD., Osaka (JP)

(72) Inventors: Kazuhiro TSUCHIYA, Osaka (JP); Kenji KATAOKA, Osaka (JP)

(73) Assignee: CAPCOM CO., LTD., Osaka (JP)

(21) Appl. No.: 15/318,804

(22) PCT Filed: Feb. 25, 2015
(86) PCT No.: PCT/JP2015/000962

§ 371 Date: Dec. 14, 2016

(30) Foreign Application Priority Data
Jun. 16, 2014 (JP) 2014-123086

(51) Int. Cl. A63F 13/2145; A63F 13/537; A63F 13/42

(52) U.S. Cl. CPC A63F 13/2145; A63F 13/42; A63F 13/537

(57) ABSTRACT

A game device including a virtual operation device display module and an operation input control module. The virtual operation device display module displays a virtual operation device showing an object for a predetermined operation input made by a user on the screen. The operation input control module sets a predetermined operation input area for the virtual operation device on the screen and executes a predetermined function related to the virtual operation device when the predetermined operation input is made towards the operation input area.

The operation input control module changes a setting range for the operation input area according to the operation input made by the users and the status of the game.

### TECHNICAL FIELD

The disclosure relates to a non-transitory storing media read by a game device, its control mechanism, and a computer device which has a virtual operation device for a game such as a button displayed on a touch panel.

### BACKGROUND OF THE INVENTION

A game which users operate in a way as described in a patent literature No. 1 and patent literature No. 2 has been sold in the market.

In these types of games, users operate the game by touch-input through a touch pen or using their fingertips to the virtual operation device displayed on the screen with the touch panel.

In addition to this, the users operate the game by input operation through an input device such as using a mouse which operates a movable pointer on the game screen towards the virtual operation device displayed on the screen.

These operations are used in a game where a predetermined virtual operation device is used to match the timing of tapping operations with the music.

A game screen image showing the game in process apart from the virtual operation device is displayed on the game screen.

For this reason, it is usually rare for the users to see the virtual operation device upon its input while watching the game screen image.

Especially as described in Patent Literature No. 2, in the game device including the display showing the game screen image and the display with a touch panel showing the virtual operation device, the movement of the eye becomes larger when the users try to watch both the game screen image and the virtual operation device at the same time.

Especially in the game device where the display showing the game screen image and the display with a touch panel showing the virtual operation device is in a separate setting, the movement of the eye becomes larger when the users try to watch both the game screen image and the virtual operation device at the same time.

For this reason, the users often input by touching without seeing the touch panel displaying the virtual operation device and only see the game screen image.

### PRIOR ART REFERENCE

### Patent Literature

Patent Literature No. 1: Japanese Patent Application No. 4937421

Patent Literature No. 2: Japanese Laid-Open Patent Application Publication No. 2006-340744.

### SUMMARY OF INVENTION

### Technical Problem

In general, the operation of the virtual operation device is effective (successful) only when the touch-input is made at a predetermined timing within the area where the virtual operation device is displayed (hereafter the virtual operation device display area) and any touch-input made outside the virtual operation device display area is invalid in these types of the game.

However, in such game where it is difficult for the users to distinguish the virtual operation device display area, it is assumed that the users may touch outside the virtual operation device display area even though the users intended its touch-input within the virtual operation device display area.

Therefore, if the touch-input within the virtual operation device display area is determined strictly to those users who are not used to these types of game operation, the degree of difficulty of the game is increased against the intention of a game developer.

The disclosure is aimed to provide a non-transitory storing media with an ability to read through control mechanism, computer device, and a game device which does not significantly change the degree of difficulty of the game against the intention of the game developer without losing the variety of the game element.

### Solution of Problem

A game device related to the embodiment includes a virtual operation device display module displaying a virtual operation device indicating a predetermined operation input by the users on a screen and an operation input control module setting an operation input area corresponding to the virtual operation device on the screen and executing a predetermined function related to the virtual operation device when the predetermined operation input has been made to the operation input area. The operation input control module changes a setting area of the operation input area according to an aspect of the operation input made by the users and according to the status of the game.

### Effect of the Invention

The disclosure provides the non-transitory storing media with an ability to read through control mechanism, computer device, and the game device which does not significantly change the degree of difficulty of the game against the intention of the game developer without losing the variety of the game element.

### BRIEF DESCRIPTION OF THE DRAWINGS

FIG. 1 is a front view illustrating the external constitution of the game device relating to the present embodiment of the present invention.

FIG. 2 is a block diagram illustrating an internal constitution of the game device.

FIG. 3 is a block diagram illustrating a functional constitution of control unit in the game device.

FIG. 4A is a diagram illustrating an overview of the game executed in the game device relating to the present embodiment of the present invention. FIG. 4A illustrates an example photo image displayed on a second display.

FIG. 4B is a diagram illustrating an overview of the game executed in the game device relating to the present embodiment of the present invention. FIG. 4B illustrates an example photo image displayed on a first display.

FIG. 5 is a pattern diagram illustrating the operation input area set individually to each virtual operation device VB1 and VB2 on the present embodiment.

FIG. 6 is a flowchart illustrating an operation input control on the present embodiment.

FIG. 7 is a pattern diagram illustrating the change in the operation input area on the present embodiment.

FIG. 8 is a pattern diagram illustrating the operation input area set in the virtual operation device VB1 as a variation to the present embodiment.

### DESCRIPTION OF EMBODIMENTS

### Overview of Embodiments

The overview of the embodiments is explained, as follows. As described, in the game where usually the touch-input is made without seeing the touch panel displaying the virtual operation device and only see the game screen image, if the touch-input within the virtual operation device display area is determined strictly to those users who are not used to these types of game operation, the degree of difficulty of the game will be increased against the intention of the game developer. Inventors of this embodiment have considered these points and came up with an idea to relieve those users who are not used to these types of game operation from these problems.

Moreover, the inventors of the embodiment have considered to determine any touch outside the virtual operation device display area to be effective so long as the touch-input is made near the virtual operation device display and to set the virtual operation device display area for the virtual operation device to be larger or bigger.

However if we allow such aid unlimitedly, any intentional touch outside the virtual operation device display area may also be recognized as an appropriate operation and this could lead to decreasing the degree of difficulty of the game more than necessary.

For example, in a case when there are two virtual operation device display areas displayed next to each other on a screen with a touch panel.

In this case, if any touch made to a boundary area of those two virtual operation device display areas is determined to be an effective operation input, the touch-input made to either of the virtual operation device will be a matter of timing when such touch-input is made to the boundary area.

This exception could lead to decreasing the game element of selecting both two virtual operation devices.

Therefore the inventors conceived of changing the setting area of the operation input area according to the aspect of the operation input made by the users and according to the status of the game.

By doing this, the inventors came up with the non-transitory storing media with an ability to read through control mechanism, computer device, and the game device which does not significantly change the degree of difficulty of the game against the intention of the game developer without losing the variety of the game element.

The game device related to one of the aspect of the related embodiment includes a virtual operation device display module displaying a virtual operation device indicating a predetermined operation input by the users on the screen and an operation input control module setting an operation input area corresponding to the virtual operation device on the screen and executing the predetermined function related to the virtual operation device when the predetermined operation input has been made to the operation input area. The operation input control module changes the setting area of the operation input area according to the aspect of the operation input made by the users and according to the status of the game.

The operation input area maybe shifted from a second area to a first area when the operation input by the users meet the predetermined conditions of a third area included in a second area but excluding a first area, where the operation input control module is set in the operation input area of the second area including the predetermined first area.

The operation input control module may make the operation input area gradually smaller from the second to the first area according to the number of times the operation input have been made by the users.

The virtual operation device display module may conform the area displaying the virtual operation device to the first area regardless of the size of the operation input area.

The virtual operation device display module displays the two virtual operation devices next to each other and the operation input control module may set each operation input area to overlap part of the operation input area's maximum area corresponding to one of the two virtual operation device with part of the operation input area's maximum area corresponding to the other remaining virtual operation device.

The control method of the game device relating to other aspect of the embodiment includes a virtual operation device display step displaying the virtual operation device indicating the target for the predetermined operation input made by the users on the screen, an operation input control step setting the predetermined operation input area corresponding to the virtual operation device on the screen and executing the predetermined function related to the virtual operation device when a predetermined operation input is made to the operation input area, and the operation input control step changes the setting area of the operation input area according to the status of the operation input made by the users and the status of the game.

A non-transitory storing media relating to another aspect of the embodiment readable by a computer device, which stores an viable instructions from a control unit includes the instructions of the virtual operation device display step displaying the virtual operation device indicating the target for the predetermined operation input by the users on the screen and setting the predetermined operation input area on the screen corresponding to the virtual operation device and the instructions where the operation input control step executing the predetermined functions related to the virtual operation device when the predetermined operation input is made to the operation input area.

The operation input control step changes the setting area for the operation input area according to the operation input made by the users and the status of the game.

The non-transitory storing media with an ability to read through control mechanism or computer device, and the game device for carrying out the embodiment of the invention is explained hereto by referring to the diagram.

The following explains by taking a game executed on the portable game device as an example.

In other words, a game with an operation input of the virtual operation device made by the users when a multiple of markers are placed to a predetermined point where such markers are moving along with the sound of the music will be described as an example in the present embodiment.

In this game, scores will be provided to the accuracy of the timing of the operational input.

[Hardware Configuration]

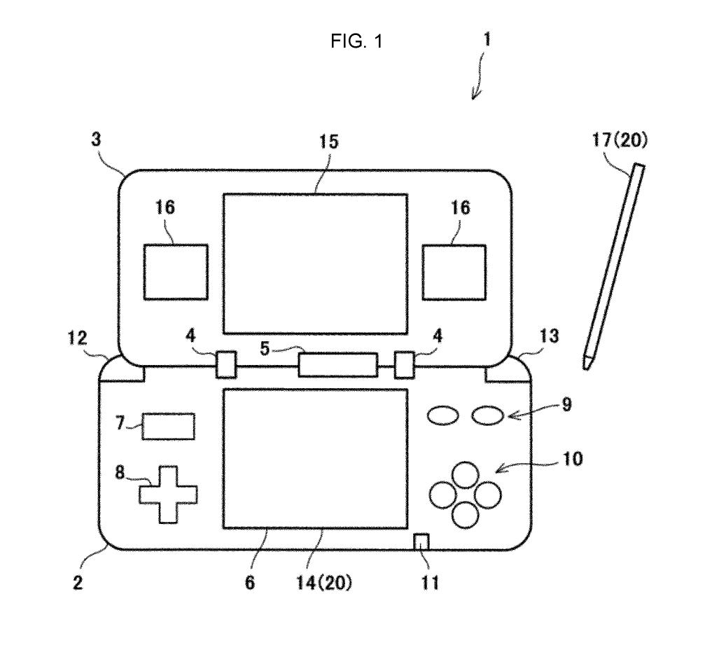

FIG. 1 is the front view illustrating the external structure of the game device 1 relating to the present embodiment of the present invention.

As illustrated in FIG. 1, the game device 1 is a portable game with a lower body 2 being laterally long and having a thin rectangular solid-shape and a upper body 3 having the same rectangular solid-shape.

A hinge 4 is erected between an upper portion of the lower body 2 and a lower portion of the upper body 3.

The lower body 2 and the upper body 3 are relatively turnable around the spindle towards both left and right direction running through hinge 4.

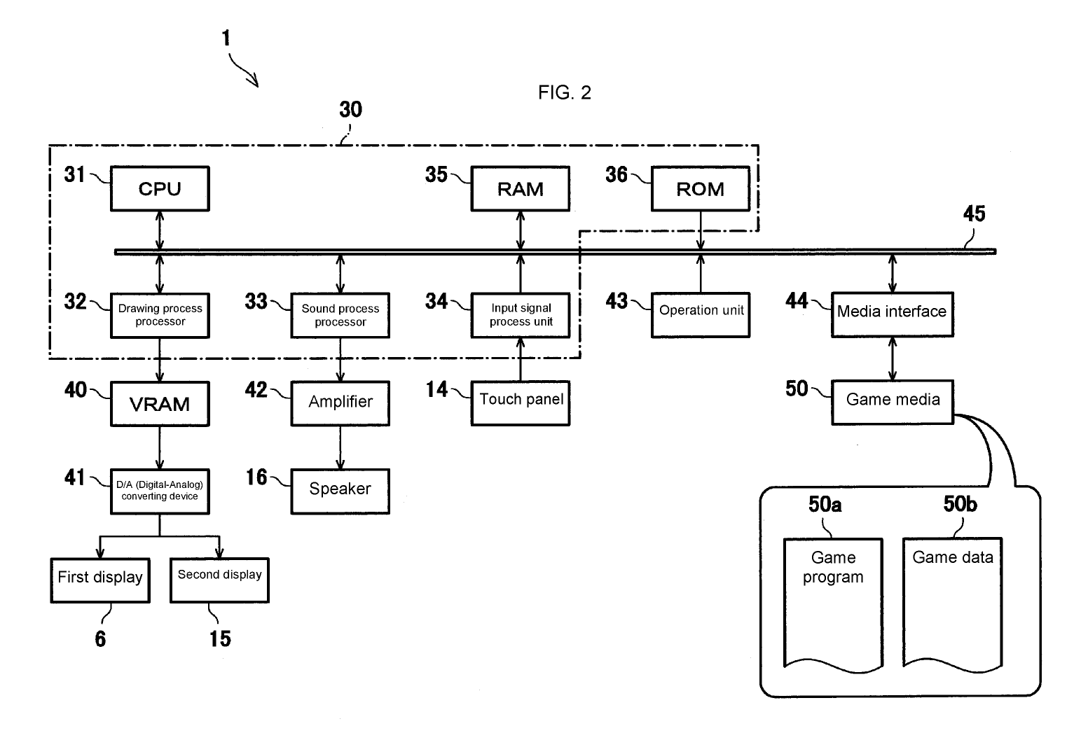

Therefore, it is possible to shift from a closed status where a front side of the lower body 2 and a front side of the upper body 3 face each other, to an open status where the front side of the lower body 2 and the front side of the upper body 3 are open, as illustrated in FIG. 2.

Overview of devices set to each body 2 and 3 are explained as follows.

A rectangular shaped first display (screen of the display unit) 6 with a semi-transmissive color liquid crystal display is set at the center portion of the front side of the lower body 2.

A power button 7 and a directional keypad are set one above the other, at the left-hand side of the first display 6.

An operation button 9 including two buttons and an operation button 10 including four buttons A, B, X and Y are set one above the other, at the right-hand side of the first display 6.

There is an indicator lamp 11 showing the on/off status of the power below the operation button 10.

An L button 12 is placed at the upper left corner of the lower body 2.

An R button 13 is placed at the upper right corner of the lower body 2.

A second display 15 having a rectangular shape with a semi-transmissive color liquid crystal display is set at the center portion of the front side of the upper body 3.

A speaker 16 is placed side to side to the second display 15.

Though it is not illustrated in FIG. 1, there is a removable media interface (cf. media interface 44 in FIG.2) which a game media 50 wherein a game program (an image processing program) 50a relating to the present embodiment is stored is placed at the back of the upper body 3 and also the upper portion of the lower body 2 when the game device 1 is opened.

A device set to the lower body 2 and a device set to the upper body 3 are connected electrically through a belt-like cable 5 with multistrand wire placed near the hinge 4.

The game device 1 has a pointing device 20.

More specifically, a transparent touch panel 14 is placed on the surface of the first display 6 set to the lower body 2.

The pointing device 20 which is an input operation device includes a touch panel 14 and a touch pen 17 attached to the game device 1.

The touch panel 14 is laterally long, and has a rectangular-shape with almost identical shape and size with the full screen (display screen) of the first display 6.

The users operate the touch pen 17, and the location information (coordinate) of the contact point (input point) is output to CPU (cf. CPU 31 FIG. 2) when the touch pen tip touches the surface of the touch panel 14.

FIG. 2 is a block diagram illustrating the inner configuration of the game device 1.

The game device 1 includes a control unit 30 as illustrated in FIG. 2.

The control unit 30 includes CPU 31, a drawing process processor 32, a sound process processor 33, an input signal process unit 34, a RAM (Random Access Memory) 35, and a ROM (Read Only Memory) 36. The game device 1 also includes a VRAM (Video-Ram) 40, a D/A (Digital-Analog) converting device 41, the first display 6, the second display 15, an amplifier 42, the speaker 16, the touch panel 14, an operation unit 43 (including the power button 7, the directional keypad 8, the operation button 9, 10, the L button 12, the R button 13), a media interface 44 and a bass 45.

The CPU 31, the drawing process processor 32, the sound process processor 33, the input signal process unit 34, the RAM 35, the ROM 36, the operation unit 43, and the media interface 44 are connected by the bass 45 to enable transfer of data to each other.

The operation unit 43 includes the input operation device which includes the directional keypad 8, the operation button 9, 10, the L button 12, and the R button 13 as illustrated in FIG. 1.

The operation unit 43 receives the operation input made by the users and input the corresponding operation signals (whether there was a pressing force or not) to the CPU 31.

The operation unit 43 includes the power button 7 besides the input operation device.

An operation input to each input operation device becomes effective when the power button 7 is operated and the game device 1 is activated by supplying power to each unit.

The media interface 44 accesses the game media 50 which is a non-transitory storing media connected to outside the game device 1 and reads out a game program 50a and game data 50b which was stored to the game media 50.

The game program 50a is a program which executes the action game played on the game device 1.

The game data 50b is necessary data upon executing the game.

For example, the game data 50b includes image data for each appearing character or backgrounds, image data for information display such as the status, sound data such as sound effect or BGM, and message data made by letters or symbols.

The game media 50 may adopt a semiconductor memory or UMD (Universal Media Disc) (registered trademark) which is a type of an optical memory disc.

The game program 50a which reads from the game media 50 according to the process of the game, a load area which stores the game data 50b and a work area which is used when the CPU 31 processes the game program 50a are set in the RAM 35.

A basic program to move the game device 1 such as the game program 50a which is stored in the game media 50 or program which controls the reading out process of the game data 50b are stored in the ROM 36.

The input signal process unit 34 detects the location information of the input point (contact point) based on the coordinate on the touch panel 14 and outputs the signal indicating such location information to the CPU 31 when the users input the operation to the touch panel 14 by contacting the pen tip of the touch pen 17.

The detection of the location information of the input point is executed in a predetermined sampling cycle (for example, four times within 1/60 seconds).

The input signal process unit 34 outputs the signal indicating the location information detected each time to the CPU 31.

The CPU 31 reads all or part of the game program 50a and the game data 50b which is stored in the game media 50 to the RAM 35 through the media interface 44, executes the game program 50a according to the operation input made by the users to the touch panel 14 or the operation unit 43, and controls the progress of the game.

More specifically, the CPU 31 executes the predetermined game progress process according to the game program 50a corresponding to its operation signal when a signal is input from the touch panel 14 or the operation unit 43 by the operation of the users.

The CPU 31 displays the result of the game progress process as a screen image indicating the progress of the game (hereafter “the game screen image”) to the first display 6 or the second display 15.

Upon this display, the CPU 31 outputs the sound signals indicating the game progress (hereafter “the game sound”) to the speaker 16.

[Functional Configuration of the Control Unit]

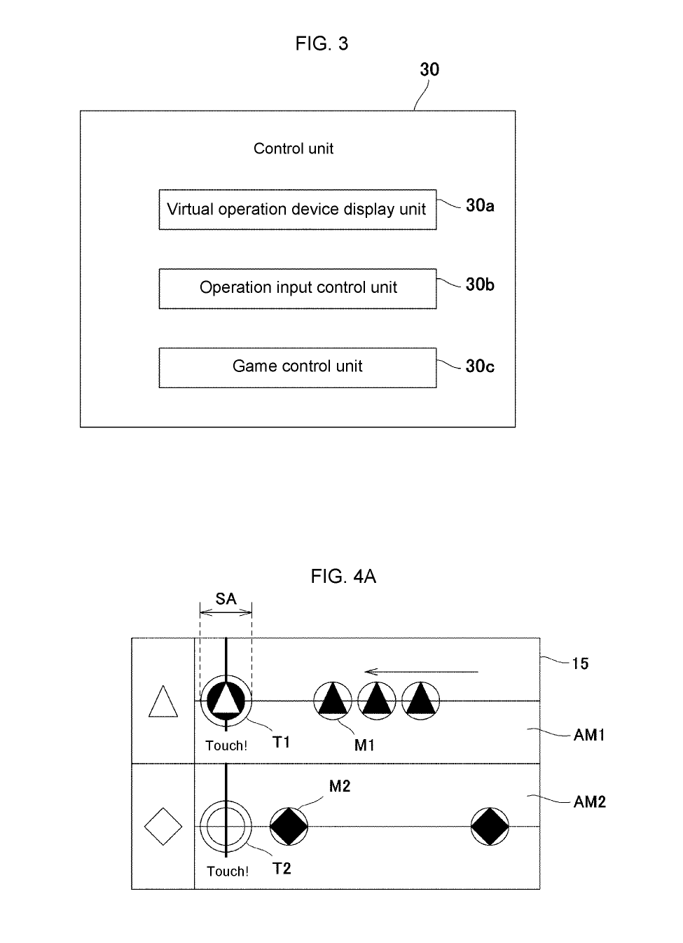

FIG. 3 is a block diagram illustrating a functional configuration of the control unit 30 included in the game device 1. FIG. 3 mainly illustrates the function necessary to put the game system into practice.

As explained, the control unit 30 moves as a computer including the CPU 31, the drawing process processor 32, the sound process processor 33, the ROM 36, and the RAM 35.

The control unit 30 of the game device 1 performs the function such as a virtual operation device display unit (virtual operation device display means, virtual operation device display module) 30a, an operation input control unit (operation input control means, operation input control module) 30b, and a game control unit (game control means, game control module) 30c by performing the game program 50a and the game data 50b being read from the game media 50.

The virtual operation device display unit 30a displays the virtual operation device indicating the subject for the predetermined operation input made by the users on the screen of the first display 6.

The operation input control unit 30b sets the predetermined operation input area corresponding to the virtual operation device on the screen.

The operation input control unit 30b performs the predetermined function related to the virtual operation device when a predetermined operation input has been done to the operation input area.

In the present embodiment, the corresponding operation input is performed by touching the surface of the touch panel 14 on the first display 6 with the pen tip of the touch pen 17 or the fingertips of the users in the location within the operation input area corresponding to such touch movement.

The game control unit 30c controls by the progress of the game according to the operation input by the users made by the pointing device 20 or the operation unit 43.

The game control unit 30c displays the game screen image based on the progress of the game on the display 15 and outputs the corresponding sound from the speaker 16.

[The Basic Movement Control of the Game]

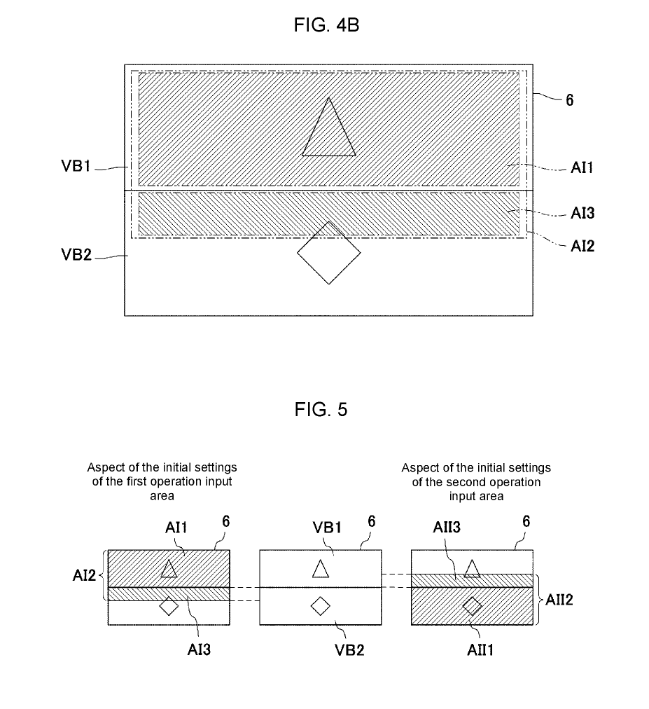

FIG. 4A and FIG. 4B are diagram illustrating the overview of the game executed in the game device 1 relating to the present embodiment of the present invention.

As illustrated in FIG.1, the game device 1 of the present embodiment has two displays 6 and 15 and displays the game screen image on these two displays.

The game of the present embodiment's operation input is made by the users with the input operation device corresponding to the virtual operation device when a multiple of markers placed to a predetermined point where such markers are moving along to the sound of the music.

The game progresses by providing scores to the users according to the accuracy of the timing of the operational input.

More specifically, as illustrated in FIG. 4A, a marker display area in which two types of marker move from right to left is displayed on the second display 15 as a main game screen.

A first marker MI is displayed on a first marker display area AM1 and a second marker M2 is displayed on a second marker display area AM2.

A first timing frame T1 and a second timing frame T2 are each displayed on the left hand area (downstream area of the moving direction of marker M1 and M2) for each of the marker display areas AM1 and AM2.

Each of the markers M1 and M2 moves from right to left and passes above each corresponding timing frame T1 and T2.

The number of the marker display areas may be one or more than three.

Moreover, a multiple types of markers (with a different marker corresponding to each virtual operation device (as described hereinafter)) may move in a single marker display area.

As illustrated in FIG.4B, a first virtual operation device VB1 and a second virtual operation device VB2 are displayed on the first display 6 by the virtual operation device display unit 30a.

The users may provide operation input (touch-input) to these two virtual operation devices VB1 and VB2.

These two virtual operation devices VB1 and VB2 are displayed next to each other.

More specifically the display area of the first virtual operation device VB1 and the second virtual operation device VB2 are placed (one above the other) so that such area could correspond to the display aspect of the timing frame T1 and T2.

Moreover in the present embodiment, the display area of the first virtual operation device VB1 and the second virtual operation device VB2 are displayed next to each other.

More specifically, each virtual operation device VB1 and VB2 have a lateral length rectangular-shape and placed so as to have each of the sides match the other sides of the rectangular-shape.

The operation input control unit 30b of the control unit 30 determines the operation input as successful and provides process for a successful input such as adding the score when the users touch-input the first virtual operation device VB1 by using the input operation device upon the first marker M1's placement to the first timing frame T1.

The operation input control unit 30b will apply the same process to the second virtual operation device VB2 for the operation input of the second marker M2.

Moreover, the timing frame T1 and T2 may set a larger area SA than the marker M1 and M2 at least in the moving direction of the marker M1 and M2.

It maybe determined as successful if there is apart which corresponds to the marker M1 and M2 within the area SA upon the touch-input.

In this case, the operation input control unit 30b determines the operation input as successful when the corresponding operation input for the virtual operation device VB1 and VB2 has been made during the frame term from the placement of the front end of the moving direction of the marker M1 and M2 to the one end (right end) of the area SA until its placement of the back end of the moving direction of the marker M1 and M2 to the other end (left end) of the area SA.

The control unit 30 may change the conditions for determining as successful according to the degree of difficulty of the game.

For example, the control unit 30 may make the area SA smaller when the degree of difficulty is high and the area SA larger when the degree of difficulty is low.

The control unit 30 may change the size of the area SA based on the users' result of the operation input (record showing whether a success or a failure).

Moreover, the control unit 30 may display a display-effect such as shining the corresponding marker M1 and M2, corresponding timing frame T1 and T2 and/or the corresponding virtual operation device VB1 and VB2 when the location of the marker M1 and M2 are in a status to be determined as successful.

Moreover, the operation input control unit 30b may provide multiple determinations such as excellent, good, passing, and failing (unsuccessful) according to the location of the corresponding marker M1 and M2 when the users touch-input the virtual operation device VB1 and VB2.

The operation input control unit 30b determines as excellent if the center location of the corresponding marker M1 and M2 upon the touch-input matches the center location of the timing frame T1 and T2, for example.

The operation input control unit 30b determines as good if the whole part of the marker M1 and M2 are within the timing frame T1 and T2, as another example.

The operation input control unit 30b determines as passing if the part of the marker M1 and M2 are within the timing frame T1 and T2, as another example.

The operation input control unit 30b determines as failing (unsuccessful) if none of the part of the marker M1 and M2 are within the timing frame T1 and T2, as another example.

Under the present embodiment, in order to have the operation input control unit 30b recognize the two consecutive touch-input operations, the users are required to retouch-input by removing the touch pen 17 or their fingertips from the touch panel 14 once after having their touch pen or their fingertips touch the touch panel 14.

This means that if the users hold or move the touch pen 17 or their fingertips in a status in which their touch pen 17 or their fingertips touches the touch panel 14, the operation input control unit 30b determines that the operation input was made only once at the location coordinate where the users touched at the beginning.

In order to determine whether the touch-input was made by the virtual operation device VB1 and VB2, the operation input area corresponding to each of the virtual operation devices VB1 and VB2 is set by the operation input control unit 30b on the first display 6.

FIG. 5 is a schematic diagram illustrating the operation input area set to each of the virtual operation device VB1 and VB2 under the present embodiment.

A diagram in the center of the FIG. 5 illustrates that the virtual operation device VB1 and VB2 are displayed on the first display 6.

A diagram at the left hand side of the FIG. 5 illustrates the initial settings of the first operation input area corresponding to the first virtual operation device VB1.

A diagram at the right hand side of the FIG. 5 illustrates the initial settings of the second operation input area corresponding to the second virtual operation device VB2.

FIG. 4B illustrates the initial settings of the first operation input area corresponding to the first virtual operation device VB1.

As an initial setting, the first operation input area is set to have a larger second coverage AI2 which is larger than a predetermined first coverage AI1.

Under the present embodiment, a first coverage AI1 is set to match the display area of the first virtual operation device VB1 as illustrated in FIG. 4B and FIG. 5.

Moreover, a coverage corresponding to the upper end of the second virtual operation device VB2 is set as a third coverage AI3.

The second coverage AI2 is set to include these first coverage AI1 and the third coverage AI3 which is set next to each other.

As illustrated in FIG.5, a first coverage AII1, a second coverage AII2 and a third coverage AII3 are set to the second operation input area in the same way.

The first coverage AII1 matches the display area of the second virtual operation device VB2 and the third coverage AII3 is set as a coverage corresponding to the lower end of the first virtual operation device VB1.

The second coverage AII2 is set to include these first coverage AII1 and the third coverage AII3 which is set next to each other.

In the initial settings, the first operation input area (the second coverage AI2) and the second operation input area (the second coverage AII2) are both set to have the maximum coverage area.

Part of both the two areas overlaps each other.

The setting coverage of each of the operation input areas change according to the aspects of the operation input by the users as described hereafter.

Under the present embodiment, the display area of the virtual operation device matches the first coverage notwithstanding the size of the operation input area.

The explanation above on the initial settings of the first operation input area and the second operation input area is only an example and the present invention is not limited to it.

For example, the third coverage AI3 regarding the first operation input area may be set as not to be included in the first coverage AI1 and not to be limited to the coverage corresponding to the upper end of the second virtual operation device VB2.

The same applies to the third coverage AII3 regarding the second operation input area.

Moreover, the display area of the first coverage AI1 and the first virtual operation device VB1 don't have to match each other and the display area of the first coverage AII1 and the second virtual operation device VB2 don't have to match each other, as well.

In addition to this, each of the operation input area need not to be the maximum area at the initial settings.

For example, each of the operation input area may be expanded from the initial settings according to the aspects of the operation input by the users.

The third coverage AI3 and AII3 set at the initial settings are set to be different from each other according to the degree of difficulty which was input at the beginning of the game.

The third coverage AI3 and AII3 becomes larger if the degree of difficulty is low and the third coverage AI3 and AII3 becomes smaller if the degree of difficulty is high.

The third coverage AI3 and AII3 may be set to be non-existent (the same operation input area as the first coverage AI1 and AII1) in the most difficult mode.

The operation input control unit 30b determines the proficiency (the accuracy of operation) of the users from the operation input results (success and failure history) and may make adjustments to the third coverage AI3 and AII3 during playing the game.

For example, the third coverage AI3 and AII3 may change according to the number of failure in the predetermined timing.

In a game where the predetermined physical energy value decreases upon any failure operations, the third coverage AI3 and AII3 may change according to the remaining physical energy value at the predetermined timing.

Whether the third coverage AI3 and AII3 may be set or not may be set according to the status of the game.

The moving speed of the marker (tempo of the music) and the space of the marker (degree of difficulty) are included in the status of the game.

For example, if the marker MI is placed in the timing frame T1 consecutively time wise (in a time when virtual operation device VB1 shall be operation input continuously), the third coverage AI3 may be set to be non-existing.

In a case when different virtual operation devices VB1 and VB2 are operated to input for two consecutive times, the third coverage AI3 and AII3 may be set to be existing.

Moreover, the third coverage AI3 and AII3 may be set to be non-existing for a predetermined term during playing the game.

For example, if an irregular operation is required to the users for the virtual operation device VB1 (for example a long pressing operation, flick operation and repeatedly strike operation, etc.), the third coverage AI3 may be set to be non-existing.

Moreover, for example, if a correct operation input is especially required to the users in an important situation in the progress of the game, the third coverage AI3 and AII3 may be set to be non-existing.

The size of the third coverage AI3 and AII3 may be changed according to the status of the game.

[Setting Area Control of the Operation Input Area]

The operation input control unit 30b may change the setting area of the operation input area according to the aspect of the operation for the input operation device by the users and the status of the game.

More specifically, the operation input control unit 30b controls the setting area for the operation input area to be shifted between the first coverage AI1, AII1 and the second coverage AI2, AII2.

For example, the operation input control unit 30b shifts the operation input area from the second coverage AI2, AII2 to the first coverage AI1, AII1 in a case when the operation input area is set in the second coverage AI2, AII2 which includes the first coverage AI1, AII1 when the operation input by the users have been made for a couple of predetermined times to the third coverage AI3 and AII3.

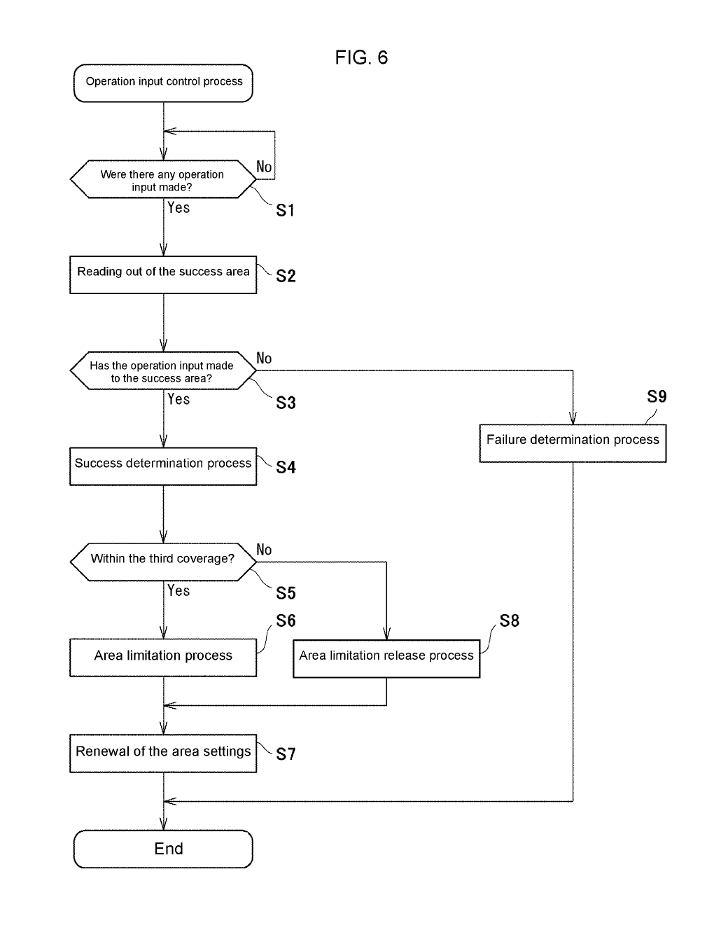

FIG. 6 is a flowchart illustrating an operation input control on the present embodiment.

As described hereto, the game control unit 30c progresses the game according to the operation input made by the users by the operation unit 43 and displays the game screen image based on such game progress on the second display 15.

The virtual operation device display unit 30a displays the virtual operation device VB1 and VB2 on the first display 6.

The operation input area set for corresponding to the virtual operation device VB1 and VB2, which displays on the first display 6 according to the progress of the game based on the game program 50a and the game data 50b, is temporarily stored in the RAM 35.

The operation input control unit 30b determines the existence or non-existence of the operation input by the input operation device to the virtual operation device VB1 and VB2 in the progress of the game (hereafter “Step S1”).

The operation input control unit 30b reads out from the RAM 35 (Step S2) the operation input area (success area) as set in the virtual operation device corresponding to the operation input to be determined as successful at the point where the operation input has been made when it determines that the operation input has been made (Yes at Step S1).

For example, as illustrated in FIG. 4, the first operation input area (the second coverage AI2) corresponding to the first virtual operation device VB1 is read out when the first marker M1 is placed within the first timing frame T1 at the point of the operation input.

The operation input control unit 30b determines the success and failure of whether the operation input has been made to the success area based on the location of the operation input by the users or the success area read out (Step S3).

More specifically, the operation input control unit 30b determines whether the location coordinates of the operation input made by the users (touch-input made through the touch pen 17) is within the success area read out by the operation input control unit 30b.

The determination of the success and failure is not limited to the above aspects.

For example, the operation input control unit 30b may specify the virtual operation device VB1 and VB2 which includes the location coordinate at which the operation input was made by the users as an operation input area, and may determine whether the specified virtual operation device is the virtual operation device corresponding to the operation input to be determined as successful at the point where such operation input was made.

The game control unit 30c performs the success determination process (Step S5) when it is determined that the location of the operation input is within the success area (Yes at Step S3).

Specifically, the game control unit 30c, for example, adds the score, increases the physical strength gauge, increases the number of counts for the consecutive success, displays on the game screen the display-effect regarding the success of the operation input, and rings a sound-effect as a success determination process.

As described here above, the game control unit 30c performs a different process according to each determination results upon making the success determination process when there is a multiple determination results (excellent, good, passing, etc.).

Moreover, the operation input control unit 30b determines whether the location of the operation input is outside of the display area of the corresponding virtual operation device VB1 and VB2 which means to determine whether it is within the third coverage AI3 and AII3 (Step S5).

As illustrated in FIG. 4, the operation input control unit 30b determines whether it is within the third coverage AI3 of the first virtual operation device VB1.

The operation input control unit 30b performs an area limitation process for the virtual operation device VB1 and VB2 (Step S6) when the location of the operation input is within the third coverage AI3 and AII3 of the corresponding virtual operation device VB1 and VB2 (Yes at Step S5).

The operation input control unit 30b shifts the operation input area from the second coverage AI2 and AII2 to the first coverage AI1 and AII1 when the operation input were made for a predetermined number of times by the users to the third coverage AI3 and AII3 upon the area limitation process.

The operation input control unit 30b may make the operation input area gradually smaller from the second coverage AI2 and AII2 to the first coverage AI1 and AII1 according to the number of operation inputs made by the users (for example, accumulated number of times for the operation input made to the third coverage AI3 and AII3).

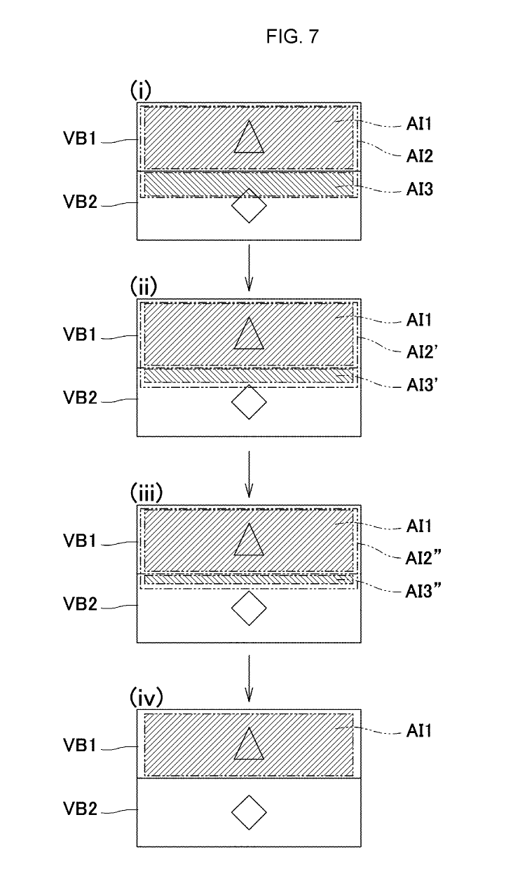

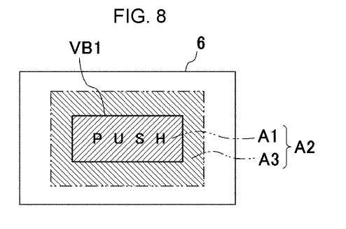

FIG. 7 is a pattern diagram illustrating the change in the operation input area on the present embodiment.

The status illustrated in (i) of FIG. 7 is the initial status (the same status as FIG. 4B).

In the area limitation process of the Step S6, the setting area for the operation input area to the operation input made after this status is changed to the status illustrated in (ii) (AI3′<AI3) when the success area read out in Step S2 is the status indicated in (i) (the second coverage AI2).

In the status illustrated in (ii), the third coverage AI3′ is shrinking from the third coverage AI3 illustrated as the status in (i) and as a result, the operation input area is changed from the second coverage AI2 to a smaller second coverage AI2′.

In the same manner, if the success area read out in Step S2 is in a status illustrated in (ii) (second coverage AI2′), the setting area for the operation input area to the operation input made after this status is changed to the status illustrated in (iii) (AI3″<AI3′).

Moreover if the success area read out in Step S2 is in a status illustrated in (iii) (second coverage AI2″), the setting area for the operation input area corresponding to the operation input made after this status is changed to the status illustrated in (iv).

In the status illustrated in (iv), the third coverage AI3 is not set and the first coverage AI1 with the same size as the display area of the virtual operation device VB1 and VB2 is the only setting area for the operation input area.

If the success area read out in Step S2 is in a status illustrated in (iv), the status illustrated in (iv) is maintained as the setting area for the operation input area corresponding to the operation input made after this status.

The operation input area in which its setting area is changed may only be the operation input area corresponding to the virtual operation device set as the success area at that time.

The operation input area in which its setting area is changed may be the operation input area corresponding to more than two virtual operation devices including the virtual operation device set as the success area at that time.

The operation input control unit 30b updates the information on the success area by storing the setting area of the operation input area after the change to the RAM 35.

As a result of this, the success area to be readout (Step S2) will become the success area after the update for the next operation input.

The setting area of the operation input area changes according to the aspect of the operation to the virtual operation device VB1 and VB2 of the users in the present embodiment.

Therefore this enables to avoid the game from significantly change the degree of difficulty against the intention of the game developer without losing the variety of the game element and provide a relief measures to those users who are not used to these types of game operation.

Especially, in a case where the virtual operation device VB1 and VB2 are placed close to each other (in the present embodiment, next to each other) if the setting area is set to be larger than that of each of the virtual operation device VB1 and VB2 in order to avoid the operation input error, there is a possibility that a overlapping area may occur in the operation input area corresponding to such virtual operation device VB1 and VB2 placed close to each other as a relief for the operation input mistake.

Therefore if the operation input was made repeatedly to these operation input area, the loss of the game element may be avoided by limiting the operation input made to the overlapping area and to induce such operation input of the virtual operation device VB1 and VB2 to be appropriately distinguishable.

Even if the display area of a multiple virtual operation device is not placed next to each other, in other words, if they do not share the same boundary and there is a space between the virtual operation devices, the effect of the present embodiment are still the same.

Moreover, even to the aspect of part of the setting area for each operation input area overlapping each other or to the aspect of the interval between the operation input areas becoming shorter due to the expansion of the setting area, the effect of the present embodiment are still the same.

More specifically, in a case when the operation input has been made to a different place due to the users' unclear operation input which was against the users' intention, a relief measures will be provided. If such operation input was made to the operation input area repeatedly, the embodiments avoid the loss of game element by limiting the operation input made to the overlapping area and to induce such operation input of the virtual operation device VB1 and VB2 to be appropriately distinguishable.

Under the present embodiment, the operation input control unit 30b performs an area limitation release process to the virtual operation device VB1 and VB2 (Step S8), when the location of the operation input is not within the corresponding third coverage AI3 and AII3 of the virtual operation device VB1 and VB2, in other words, when the location of the operation input is in the first coverage AI1 and AII1 (No at Step S5) which matches the display area of the corresponding virtual operation device VB1 and VB2.

Under the area limitation release process, the operation input control unit 30b shifts the setting area for the operation input area to the second coverage AI2, AII2 which is the initial status from the size of the present settings.

The operation input control unit 30b may, for example in the same manner as the area limitation process, increase the size of the third coverage AI3 and AII3 in a step-by-step manner (i.e., may be changed in an order, with a status illustrated in FIG. 7 as (vi), (iii), (ii) and (i)).

The operation input control unit 30b may recover the setting area to the initial status at one shot (in the status as illustrated in FIG. 7 (i)) as an alternative to the above mentioned manner.

The operation input control unit 30b may also recover the setting area to the initial status when the operation input to the first coverage AI1 and AII1 is consecutively made for the predetermined number of times.

The operation input control unit 30b may use how many times there are grades of excellent, good, and passing, use whether the existence or non-existence of failure (unsuccessful), and use how many times there are of the existence and non-existence of failure during the predetermined term as a decision material for determining whether or not to recover the setting area to the initial status.

Moreover, the setting area of the operation input area may continuously (seamlessly) become smaller or bigger in size from the third coverage AI3 and AII3 according to the result of the operation input.

The setting area of the operation input area may change to a smaller area than the first coverage AI1 and AII1 (i.e., the display area of the virtual operation device VB1 and VB2) according to the result of the operation input.

From these embodiments, it is possible to set the difficulty of the game higher to those users with high play skills by its operation input area becoming smaller.

Even with these area limitations, it is possible to re-provide an effective relief measures for the operation input mistakes to the virtual operation device VB1 and VB2 by releasing the area limitations when an appropriate operation input was made to the virtual operation device VB1 and VB2.

The game control unit 30c performs a failure determination process (Step S9) if it determines that the location of the operation input is not within the success area in the Step S3 (No at Step S3).

Specifically, the game control unit 30c, for example, decreases the physical strength gauge, resets the number of counts for the consecutive success, displays on the game screen the display-effect regarding the failure of the operation input, and outputs a sound-effect as a failure determination process.

Under the present embodiment, the area limitation release process will not be performed if determined as failure; however, the area limitation release process (Step S8) may be performed by the operation input control unit 30b even though it was determined as failure.

The operation input control unit 30b may change the aspect of the area limitation process based on the users' operation input results (record showing whether a success or a failure) by storing the users' operation results (such as excellent, good, passing, and failing).

For example, the operation input control unit 30b may make the area limitation process stricter if the number of excellent operation input is made more than the predetermined number of times in a certain number of the operation input.

For example, the operation input control unit 30b may reduce a number of times allowing the operation input to the third coverage AI3 and AII3.

On the other hand, the operation input control unit 30b may loosen the area limitation process if the number of failing operation input is made more than the predetermined number of times in a certain number of the operation input.

For example, the operation input control unit 30b may increase a number of times allowing the operation input to the third coverage AI3 and AII3.

The operation input control unit 30b may change the aspect of the area limitation according to the number of times by counting such number of times of the area limitation process which was made when the area limitation process was performed.

For example, under the present embodiment here above, the operation input control unit 30b sets the setting area in a status where the third coverage AI3 and AII3 does not exist when the users input by touching the third coverage AI3 for a three consecutive times as illustrated in FIG. 7.

In such case, the status becomes as illustrated in (iv) where only the first coverage AI1 exists.

As a substitute, the operation input control unit 30b may release the area limitation once, if the status has become as illustrated in FIG. 7 (iv), and may change the setting area where the third coverage AI3 and AII3 does not exist by the touch-input made only once to such third coverage AI3 and AII3 when the area limitation process is performed again.

The game control unit 30c may be controlled so as to annunciate the changes when the setting area on which the operation input area is based is changed.

For example, the game control unit 30c may display the flashing display or change the display color of the virtual operation device VB1 and VB2 as an annunciate aspect.

Moreover the game control unit 30c may display the message on the game screen (the first display 6 or the second display 15) or may display by lighting up a lamp when the setting area of the operation input area is restricted.

The restriction of setting area of the operation input area may be annunciated by a sound.

The present invention is not limited to the present embodiment as explained here above, and may be improved, altered, or modified for various points without departing from the scope of the invention.

For example, under the present embodiment, an explanation was made to a case in which the third coverage AI3 and AII3 becomes smaller each and every time the operation input was made to such third coverage AI3 and AII3; however, the present embodiment may not be limited to this case.

As another example, the third coverage AI3 and AII3 may become smaller when the operation input to the third coverage AI3 and AII3 was made repeatedly for a predetermined number of times.

In other words, the setting area of the operation input area may be set as not to be changed if the number of times of the operation input is below the predetermined number of times.

Moreover, under the present embodiment, the second coverage AI2, AII2 which the operation input area is wider than the first coverage AI1 and AI1 with the same size as the virtual operation device VB1 and VB2 changes upon the area limitation process.

As a substitute, the setting area for the operation input area may be changed to a smaller area than the display area of the virtual operation device VB1 and VB2 upon the area limitation process.

Under the present embodiment, the display area of the virtual operation device VB1 and VB2 doesn't change but the setting area for the operation input area is the only thing that changes.

As a substitute, the display area of the virtual operation device VB1 and VB2 may change according to the operation input area.

In the present embodiment here above, two virtual operation devices VB1 and VB2 have been explained; however, the present invention may be applied to one or more than three virtual operation device(s).

Moreover, the area limitation process such as the above present embodiment may be performed to only part of the virtual operation device and the area limitation process may not be performed to the remaining virtual operation device when a multiple virtual operation device is prepared.

FIG. 8 is a pattern diagram illustrating the operation input area set to the virtual operation device VB1 as a variation in the present embodiment.

If the present invention is applied to one virtual operation device such as illustrated in FIG. 8, the first coverage A1 which matches the display area of the virtual operation device VB1 is set, and the third coverage A3 which surrounds the first coverage A1 is set.

Then, the area including the first coverage A1 and the third coverage A3 will be set as the second coverage A2.

In the initial settings, operation input area corresponding to the virtual operation device VB1 is set to the second coverage A2.

An operation input control process as explained in FIG. 5 will be performed in the operation input area.

Moreover, in the present embodiment here above, the operation input to the third coverage AI3 and AII3 is always allowed if the third coverage AI3 and AII3 is set (then the area limitation will be performed).

As a substitute, for example, whether the operation input is allowed or not may be determined at the predetermined probability upon the operation input to the third coverage AI3 and AII3.

The portable game device is explained in the present embodiment; however, the present invention may be preferably applied to non-portable game console, cellular phone, and computers such as personal computer, as well.

The present invention may be applied to those devices without any touch panels. For example, the users may place the pointer on the virtual operation device (predetermined input area such a button icon) displayed on the game screen, which moves all over the game screen according to the operation input made by the input operation device by using a mouse or a game controller as the input operation device. By placing such pointer on the virtual operation device and performing a button input operation, the present embodiment maybe applied to such aspects of performing the predetermined functions.

### INDUSTRIAL APPLICABILITY

The present invention is useful to avoid the game from significantly change the degree of difficulty against the intention of the game developer to the non-transitory storing media with an ability to read through control mechanism, computer device, and the game device.

### REFERENCE SIGNS LIST

1 game device (computer device)
14 touch panel
17 touch pen
30 control unit
30a virtual operation device display unit (virtual operation device display means, virtual operation device display module)
30b operation input control unit (operation input control means, operation input control module)
30c game control unit (game control means, game control module)
50 game media (non-transitory storing media)
VB1, VB2 virtual operation device

1. A game device comprising:
a virtual operation device display module displaying a virtual operation device showing an object for a predetermined operation input made by a user on the screen; and
an operation input control module setting a predetermined operation input area for the virtual operation device on the screen and executing a predetermined function related to the virtual operation device when the predetermined operation input is made towards the operation input area;
wherein the operation input control module the setting range for the operation input area is changed according to the operation input by the users and the status of the game.

2. The game device according to claim 1,
wherein shifting the operation input area from a second area to a first area when the operation input by the users meet the predetermined conditions of a third area included in a second area but excluding a first area, where the operation input control module is set in the operation input area of the second area including the predetermined first area.

3. The game device according to claim 2,
wherein the operation input control module makes the operation input area gradually smaller from the second to the first area according to the number of times the operation input have been made by the users.

4. The game device according to claim 2,
wherein the virtual operation device display module conforms the area displaying the virtual operation device to the first area regardless of the size of the operation input area.

5. The game device according to claim 1,
wherein the virtual operation device display module displays the two virtual operation devices next to each other, and
wherein operation input control module sets each operation input area to overlap part of the operation input area's maximum area corresponding to one of the two virtual operation device with part of the operation input area's maximum area corresponding to the other remaining virtual operation device.

6. A control method of the game device, comprising:
a virtual operation device display step displaying the virtual operation device indicating the target for the predetermined operation input made by the users on the screen;
an operation input control step setting the predetermined operation input area corresponding to the virtual operation device on the screen and execute the predetermined function related to the virtual operation device when a predetermined operation input is made to the operation input area; and
an operation input control step changing the setting area of the operation input area according to the status of the operation input made by the users and the status of the game.

7. The control method of the game device according to claim 6,
wherein the operation input control step is included in the second area when the operation input area is set to be in the second area including the predetermined first area, and
wherein shifting the operation input area from the second area to the first area when the operation input by the users meet the predetermined conditions of the third area included in the second area but excluding the first area.

8. The control method of the game device according to claim 7,
wherein the operation input control step makes the operation input area smaller from the second to the first area according to the number of times the operation input have been made by the users.

9. The control method of the game device according to claim 7,
wherein the virtual operation device display step conform the area displaying the virtual operation device to the first area regardless of the size of the operation input area.

10. The control method of the game device according to claim 6,
wherein the virtual operation device display step displays the two virtual operation devices next to each other, and
wherein operation input control step sets each operation input area to overlap part of the operation input area's maximum area corresponding to one of the two virtual operation device with part of the operation input area's maximum area corresponding to the other remaining virtual operation device.

11. A non-transitory storing media readable by a computer device, which stores an viable instructions from a control unit;
wherein, the instructions include the virtual operation device display step displaying the virtual operation device indicating the target for the predetermined operation input by the users on the screen,
wherein the instructions set the predetermined operation input area on the screen corresponding to the virtual operation device;
wherein the instructions include the operation input control step executing the predetermined functions related to the virtual operation device when the predetermined operation input is made to the operation input area; and
wherein the operation input control step changes the setting area for the operation input area according to the operation input made by the users and the status of the game.

12. The non-transitory storing media according to claim 11,
wherein the operation input control step is included in the second area when the operation input area is set to be in the second area including the predetermined first area; and
wherein shifting the operation input area from the second area to the first area when the operation input by the users meet the predetermined conditions of the third area included in the second area but excluding the first area.

13. The non-transitory storing media according to claim 12,
wherein the operation input control step makes the operation input area smaller from the second to the first area according to the number of times the operation input have been made by the users.

14. The non-transitory storing media according to claim 12,
wherein the virtual operation device display step conform the area displaying the virtual operation device to the first area regardless of the size of the operation input area.

15. The non-transitory storing media according to claim 11,
wherein the virtual operation device display step displays the two virtual operation devices next to each other, and
wherein operation input control step sets each operation input area to overlap part of the operation input area's maximum area corresponding to one of the two virtual operation device with part of the operation input area's maximum area corresponding to the other remaining virtual operation device.
